(19) United States
(12) Patent Application Publication
(10) Pub. No.: US 2015/0066676 A1
(43) Pub. Date: Mar. 5, 2015

(54) Method of distribution and sales management, and quality control for a new supply chain in global trade

(71) Applicant: MINGBO LIANG, GUANGZHOU (CN)

(72) Inventor: MINGBO LIANG, GUANGZHOU (CN)

(21) Appl. No.: 14/018,450

(22) Filed: Sep. 5, 2013

(51) Int. Cl. G06Q 30/06

(52) U.S. Cl. CPC G06Q 30/0605
USPC 705/26.2

(57) ABSTRACT

A method for a global supply chain and a quality control method for its quality management, using IT technology.

Local Headquarter or Overseas Subsidiary partners with best Local Factory, Third Party Logistics Provider, IT service providers and professional Middlemen. Thus devote itself in supply chain and product quality management.

All of the products produced in the same period, from same material and out of a same machine will be assigned a serial number. This number contains the real performance of the products. The testing result of product performance is directly recorded and cannot be revised. Everyone can track it online by providing this number.

### FIELD OF THE INVENTION

The present invention relates generally to a business method in conducting global trade, in particular, to a method of distribution and sales management, and quality control for a new supply chain in global trade.

### BACKGROUND

With the economic depression and improving IT technology, traditional supply chain is no longer suitable for market. It needs a more efficient one to replace the old one, especially the small and medium businesses, to cut down unnecessary expenses and keep competitive.

As we all know, more organizations included in a supply chain, higher the price is. The same to global supply chain, there are also redundant procedures, which makes the price high. What's more, slow down the supply chain response.

In addition, defects or shoddy goods are always a risk within the supply chain and they need to be kept to a minimum to reduce the prospect of production being slowed down or even halted as a result of defects.

Thus, a method to manage the distribution, sales and quality control for the new supply chain in global chain is therefore needed.

### BRIEF SUMMARY

The present invention is related to a method of management about improving efficiency, ensuring products quality, reducing cost, add value to supply chain, and enhancing trust between organizations for a new supply chain in global trade. Eventually, value added on to the products through this supply chain which benefits manufacturers, middlemen and endusers.

The present invention makes use of ecommerce platform, like common ecommerce platform, to manage trades among buyers, sellers and middlemen. The difference is that the quality control method is applied to our platform. Also it matches the new supply chain in global trade.

The new supply chain concludes local factories, local headquarter, local and foreign third party logistics, overseas subsidiaries and overseas middlemen or end-users.

### BRIEF DESCRIPTION OF THE FIGURES

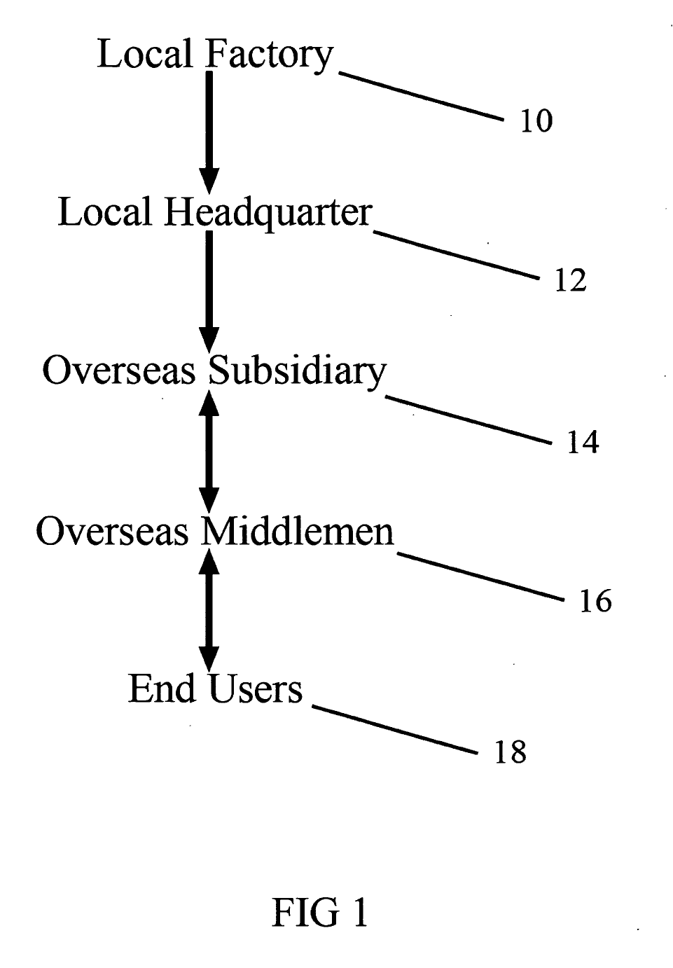

The FIG. 1 is the invented supply chain process.

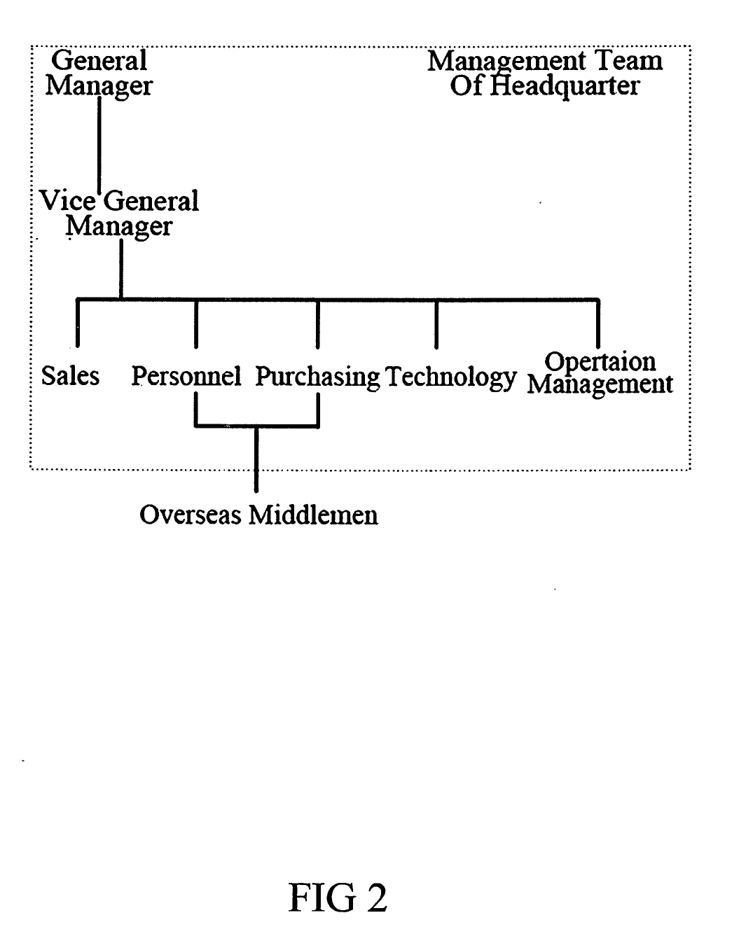

The FIG. 2 is the organizational structures of the management team in headquarter.

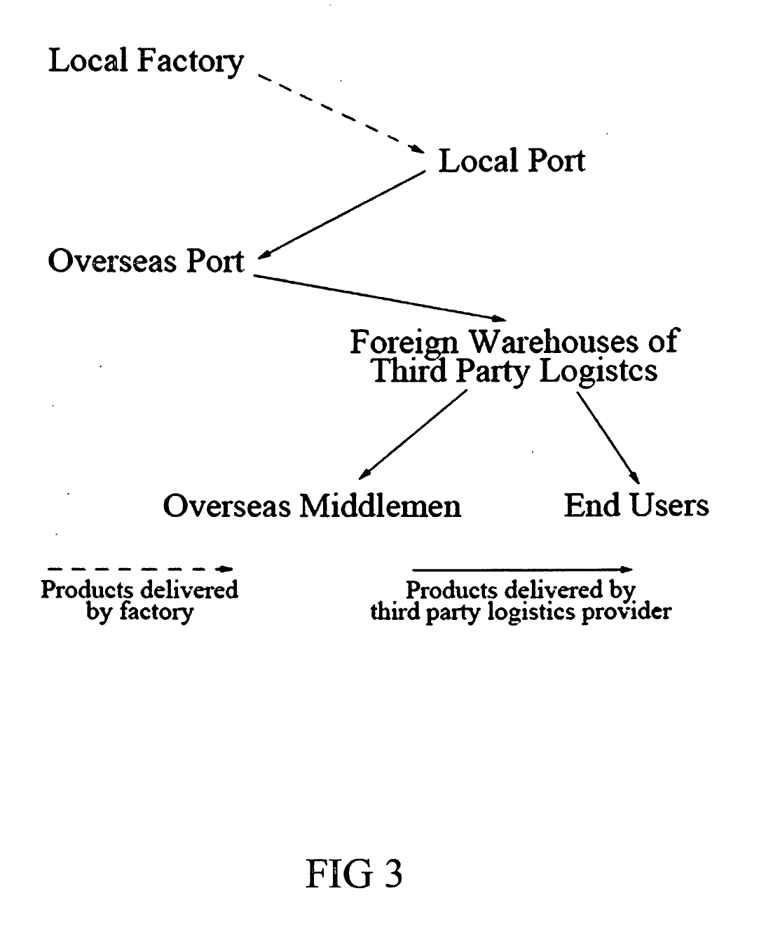

The FIG. 3 is the distribution route of products.

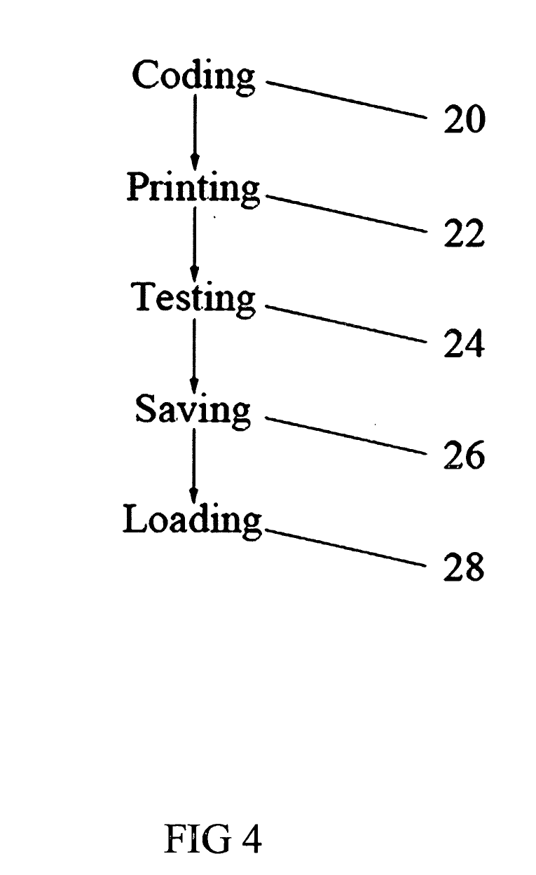

The FIG. 4 shows step of acquiring products information and reserving it for quality control.

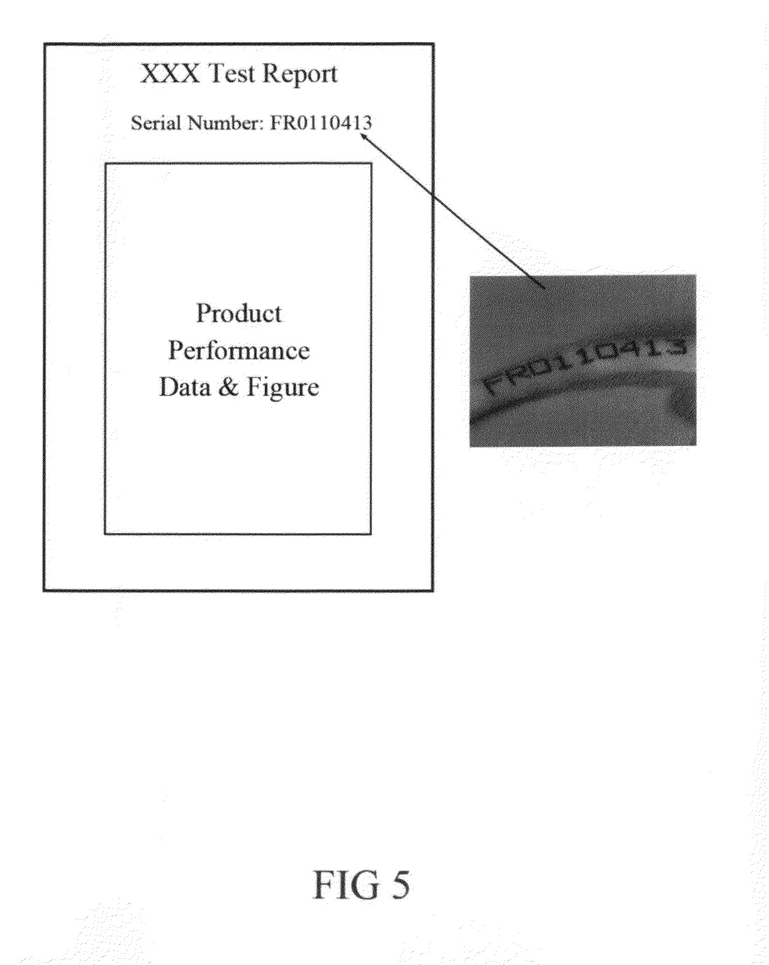

The FIG. 5 is a test report sample.

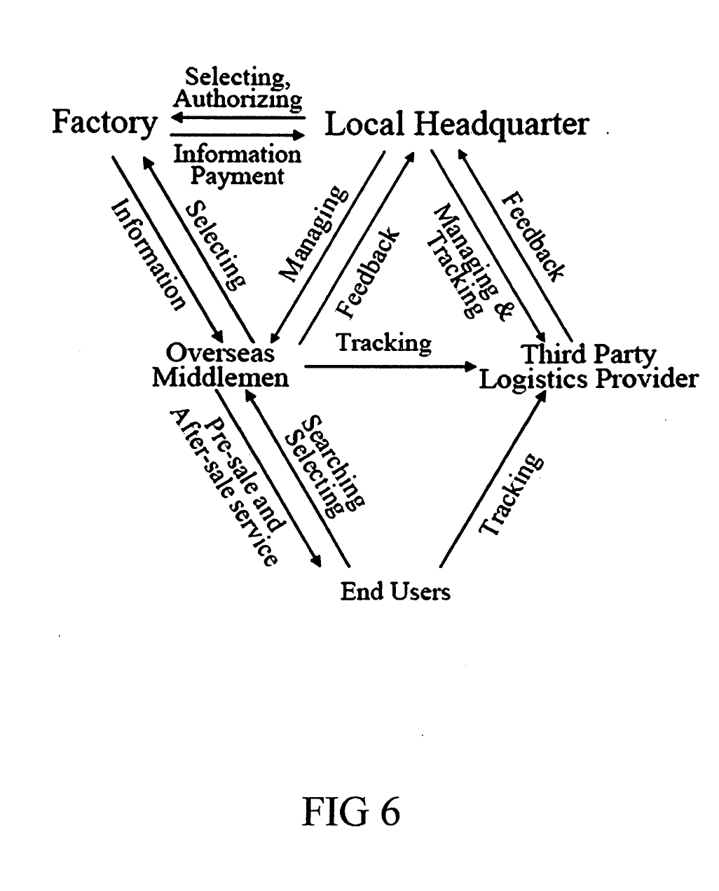

The FIG. 6 shows relationship of each others on the platform.

### DETAILED DESCRIPTION OF THE INVENTION

The present invention is a combination of many management methods, to form a most matching process for distribution and sales management, and quality control for a new supply chain in global trade.

As shown in FIG. 1, organizations in the supply chain in global trade include: Local Factory 10, Local Headquarter 12, Overseas Subsidiary 14, Overseas Middlemen 16 and End Users 18. The FIG. 1 simply illustrates the movement of products from local country to overseas.

Local Factories 10 are products manufacturers, providing products End Users 18 need. To ensure the quality of the factories and their products, Local Headquarter 12 is the core and responsible for the inspection to Local Factories 10. In addition, it is also responsible for arrangement of logistics to overseas, acting as an exporter; and Overseas Subsidiary 14 staff appointment and task assignment. Therefore Local Headquarter 12 is the core of the whole process. It must have the knowledge and the ability to manage the whole supply chain.

Overseas Subsidiary 14 are virtual offices established in target countries. They are directly managed by Local Headquarter. In the target countries, Overseas Subsidiary 14 acts as importers, registers trademark, recruits sales representatives and deals with any other business affairs. In the beginning of developing overseas market, it can largely cut down the funding to set up Overseas Subsidiary 14. And, what is important, it hires Overseas Middlemen 16 in the same country to localize sales and marketing to adapt to target countries, while enhancing customer trust.

The FIG. 2 shows the organizational structure of Local Headquarter 12 in FIG. 1. The flat organizational structure refers to an organizational structure with few or no levels of intervening management between staff and managers. The Overseas Subsidiaries are controlled by Local Headquarter, so it needs to deliver the decision made in time. With eliminating layers of middle management, comments and feedback reach all personnel involved in decisions more quickly. On the other hand, the structure cuts off redundant staff and lower labor cost. Thus the company is more efficient and flexible to adapt to this changing world.

The FIG. 3 presents a route through which products are delivered. As it shows, products are almost delivered by third party logistics. Local Headquarter looks for the best matching third party logistics provider in each country, to establish long term cooperation. Products are delivered to and stocked in foreign countries all by third party logistics providers. It takes great amount to set up an own logistics and warehouse in a foreign country, not mention to all over the world. To cooperate with third party logistic providers can save a lot; meanwhile it can cover more regions in a low cost. By the logistics provider, we store the products for sales representatives and VARs if they need.

The FIG. 4 shows steps of quality control, coding 20, printing 22, testing 24, saving 26 and loading 28. Coding 20 is that, before production, every batch of products will be assigned a unique number called serial number. It is consist of numbers 0-9 and letters A-Z. Products in the same batch will be printed a same serial number on them or their packages. If production is outsourced, the serial number should also be included into the contract.

The FIG. 5 is a sample of test report. As it shows, the number on the product is serial number and also presented in the test report. The number is unique and different by products from different batch. It means a number can only be correspondence to a batch of products. Moreover, the testing 24 should comply with the followings:
a) Products in the same batch should be produced from the same equipment. To prevent differences between testing result and real performance due to different equipments.
b) Products in the same batch should be produced from a same batch of materials. To prevent differences due to different materials.
c) Products in the same batch should be produced in a same period of time or under the same order.

All the performance data of products will be uploaded to our server. Customers can clarify how the products they bought are anywhere and anytime, so long as submit the serial number through the Internet. And for sales representatives, they promote products easier. Therefore it improves the efficiency of the whole supply chain and guarantees the quality of all products.

At last, a system or ecommerce platform will be used to manage all the things stated above. The system or platform likes the common ecommerce platform, but has something different to that. It is built through SaaS providers and all data is stored on their server. The automation of data collection for quality measures has many benefits and a steep cost. The presented invention is a way of implement automation of data collecting in relatively low cost. Through this system or platform, all the users may be involved above can:

The Local Factories 10, which is selected by the Local Headquarter 12, will be authorized to upload their products and related knowledge to the platform by paying a fee. Thus our sales representatives or VARs all over the world are able to download their documents for promotion.

For sales representatives, they promote in their territory assigned. Besides the territory, they will also receive a set of number. When they reach a deal, they should provide the number to the customer, without which the customer can not submit the order through the plat form. With the number provided, system or platform owner can distinguish that orders submitted are from which sales representatives. And the commission for the sales representatives can thus be figured out according to the order amount and contract details. If sales representatives trade with customers offline, we don't admit their due commission unless they trade with system or platform owner again through the platform.

Another reason that the transaction should be conducted through the platform is system or platform owner will set a sales goal for the sales representatives and VARs. If they do not do so, their sales amount would not be recorded on the system or platform, and eventually they will be deemed not meeting the goal.

System or platform will be integrated with system of logistics provider. All users can track their shipments through our system or platform. And the system or platform owner can also manage the inventory in each warehouses of the third party logistics provider provided. Therefore Local Headquarter 12 and Overseas Subsidiary 14 can devote themselves to developing core business while providing other services professionally. The Local Headquarter 12 and Overseas Subsidiary 14 will be more flexible and efficient.

Eventually, some may find us through search engine and they don't know any of our middlemen. Thus we need a search function in the system or platform. When buyers choose a seller, they can talk with this seller to know more about the seller and the products wanted. Moreover, if buyers want some customized product, they can post a request of describing the specification of the customized product. When any seller see the request and think he is able to produce this, he can pay for this request to get the contact information to get this order.

What is claimed is:

1. A method of distribution and sales management, and quality control for a new supply chain in global trade, comprising:
1. An ecommerce platform managing sellers including but not limited to producers, manufacturers and any entities that provide commodities, buyers including but not limited to end-users, retailers, contractors and any entities that are in need of a commodity, and middlemen including but not limited to VARs, representatives that are authorized by system owner or sellers to promote commodities in a certain territory instead of them.

2. The platform of claim 1, in specific embodiment, can automatically figure out representatives' commission by their sales amount of finished order and automatically sent to their account.

3. A quality tracking/control method, applying to and matching this new supply chain.

4. The method of claim 3, in specific embodiment, wherein the quality tracking/control method comprising following steps: coding, give a unique code to every batch of products;
printing, print the code number onto each unit of the same batch; testing, conduct a random sample testing on each batch of the products; saving, generate a test report by each batch and upload to the platform; loading, buyers or middlemen get the test reports from the platform.

5. A global supply chain comprising following: local partner factories, providing commodities or intending to develop overseas market; local headquarter, managing business with local factories and any other business affairs; overseas subsidiaries and overseas sales channels, set up in foreign countries; building relationship with different third party partners or service suppliers; flat organization, referring to a company's organizational structure.

6. The platform of claim 1, in specific embodiment, to which the method of claim 3 is applied. Users can transmit the test reports or find out corresponding reports by unique code on the products.
